(19) United States
(12) Patent Application Publication
(10) Pub. No.: US 2014/0245205 A1
(43) Pub. Date: Aug. 28, 2014

(54) KEYBOARD NAVIGATION OF USER INTERFACE

(71) Applicant: MICROSOFT CORPORATION, Redmond, WA (US)

(72) Inventor: John F. Smith, Redmond, WA (US)

(73) Assignee: MICROSOFT CORPORATION, Redmond, WA (US)

(21) Appl. No.: 13/779,601

(22) Filed: Feb. 27, 2013

(51) Int. Cl. G06F 3/0484

(52) U.S. Cl. CPC G06F 3/0484
USPC 715/767

(57) ABSTRACT

Embodiments that relate to systems and methods for navigating a user interface via a keyboard are provided. In one embodiment, one or more keystroke events corresponding to one or more keystrokes are received from a listener module. The one or more keystrokes are associated with one or more keys that correspond to a navigation direction in the user interface. A current HTML element in the user interface is identified that has a keyboard focus and may receive input from a keyboard navigation module. A destination HTML element that is nearest to the current HTML element in the navigation direction and can receive keyboard focus is located in the user interface. The keyboard focus is then moved to the destination HTML element.

### BACKGROUND

Using a keyboard instead of a mouse or trackpad to navigate a web page can be a challenge. Many web pages have no such keyboard navigation functionality provided at all, while other web pages provide extremely limited keyboard navigation options. For example, in one prior approach, one or more HTML elements may be marked with a tab stop attribute. A browser may parse the HTML and locate those elements with a tab stop attribute. A user may change the keyboard focus by using the TAB key on the keyboard to sequentially tab through those elements with a tab stop attribute.

However, while such a technique may be satisfactory in some instances, such as for simple, text based websites, it has proven less than satisfactory for navigating and interacting with more complex web pages. Tabbing through HTML elements is a serial endeavor that limits a user to advancing forward or backward through elements on a page in a defined order. Such navigation can prove tedious, particularly for complicated web pages having numerous elements. In light of this inconvenience, the usefulness of tab-based keyboard navigation for more complex web pages is limited, and many web pages are designed with little consideration or expectation of tab-based keyboard navigation.

### SUMMARY

Various embodiments are disclosed herein that relate to navigation of a user interface via a keyboard. For example, one disclosed embodiment provides a method that includes receiving from a listener module one or more keystroke events corresponding to one or more keystrokes on the keyboard. The one or more keystrokes are associated with one or more keys on the keyboard, and the one or more keys correspond to a navigation direction in the user interface.

The method includes identifying a current HTML element in the user interface that has a keyboard focus and may receive input from a keyboard navigation module. Upon receiving the one or more keystroke events, a destination HTML element that is nearest to the current HTML element in the navigation direction is located in the user interface, where the destination HTML element can receive the keyboard focus. The keyboard focus is then moved to the destination HTML element.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view of a keyboard navigation system including a keyboard navigation module and a web resource according to an embodiment of the present disclosure.

FIG. 2 is a schematic view of the display and keyboard of FIG. 1 as viewed by a user.

FIG. 3 shows a portion of pseudocode of an HTML snippet.

FIG. 4 shows a portion of pseudocode of another HTML snippet.

FIG. 5 shows a portion of pseudocode of another HTML snippet.

FIGS. 6A and 6B are a schematic view of a flow chart for a method of navigating a user interface via a keyboard according to an embodiment of the present disclosure.

FIG. 7 is a simplified schematic illustration of an embodiment of a computing system.

### DETAILED DESCRIPTION

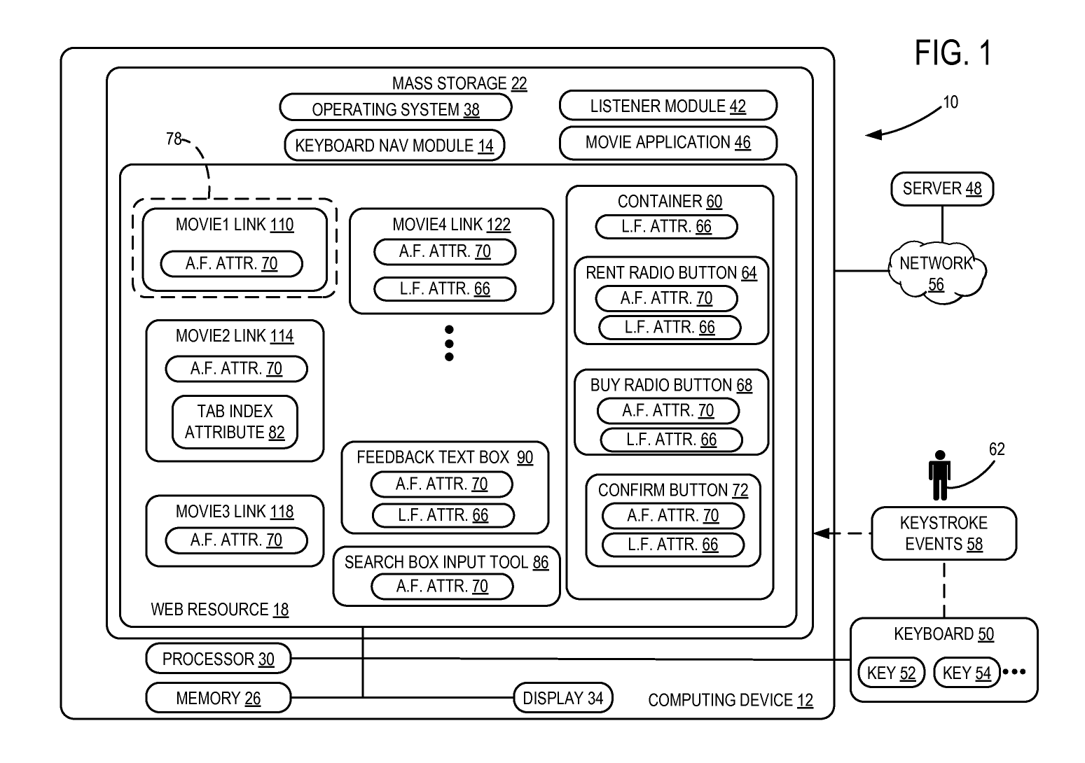

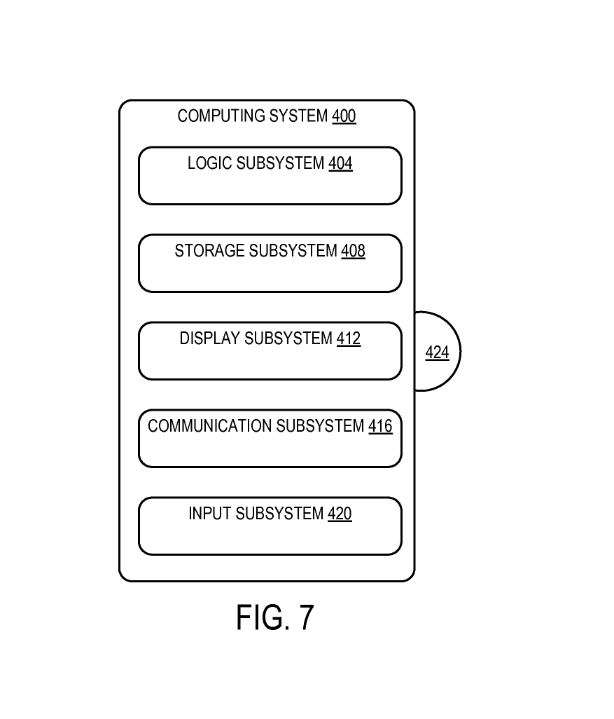

Aspects of this disclosure will now be described by example and with reference to the illustrated embodiments listed above. FIG. 1 is a schematic view of one embodiment of a keyboard navigation system 10 of the present disclosure including a computing device 12, a keyboard navigation module 14, and showing a web resource 18. In different embodiments, the computing device 12 may take the form of a desktop computing device, a mobile computing device such as a smart phone, laptop, notebook or tablet computer, network computer, home entertainment computer, interactive television, gaming system, or other suitable type of computing device. Additional details regarding the components and computing aspects of the computing device 12 are described in more detail below with reference to FIG. 7.

The computing device 12 includes mass storage 22, memory 26, a processor 30, and display 34. Programs stored in mass storage 22 may be executed by the processor 30 using memory 26 to achieve various functions described herein. Mass storage 22 may include an operating system 38 and, as described in more detail below, a keyboard navigation module 14, a listener module 42 and one or more applications, such as a movie application 46.

The computing device 12 further includes a keyboard 50 having multiple keys, such as key 52, key 54, etc. Keystroke events 58 that correspond to one or more keystrokes on the keyboard may be transmitted by the keyboard 50 and received by the listener module 42. The keyboard 50 may be operatively connected with the computing device 12 using a wired connection, or may employ a wireless connection via WiFi, Bluetooth, or any other suitable wireless communication protocol.

It will be appreciated that the keyboard 50 may take the form of any suitable input device that utilizes a plurality of keys that may be pressed or otherwise selected by a user. For example, the keyboard 50 may take the form of a mechanical typewriter-like device, an on-screen displayed keyboard, a projected keyboard in which images of keys are projected onto a surface, etc. Similarly, any suitable layout of keys may be utilized, such as QWERTY, QWERTZ, AZERTY, various non-Latin character set layouts, etc.

Additionally, the example illustrated in FIG. 1 shows the keyboard 50 as a separate component from the computing device 12. It will be appreciated that in other examples the keyboard 50 may be integrated into the computing device 12. Additionally, in other embodiments computing device 12 may include other components not shown in FIG. 1, such as other user input devices including mice, game controllers, cameras, microphones, and/or touch screens, for example.

In one example, the movie application 46 may be configured to retrieve, render, and display via display 34 web resources, such as web resource 18 that comprises an HTML file containing multiple HTML elements. As discussed in more detail below, in using the keyboard navigation system 10 and one or more keys on the keyboard 50, a user 62 may conveniently navigate among and interact with the multiple HTML elements of the web resource 18.

It will be appreciated that in some examples web resource 18 may be retrieved from a remote source, such as from server 48 via a network 56. The network 56 may take the form of a local area network (LAN), wide area network (WAN), wired network, wireless network, personal area network, or a combination thereof, and may include the Internet.

In one example, the keyboard navigation module 14 may comprise a runtime executable file such as a Javascript file downloaded from a website. In other embodiments, the keyboard navigation module 14 may comprise a Javascript class that is implemented as part of a web browser. With either configuration, the keyboard navigation module 14 may enable programmatic access to objects within the host environment. For example, as the browser renders an HTML page the keyboard navigation module 14 may identify one or more HTML elements that are capable of receiving input from the keyboard navigation module 14. It will also be appreciated that in other examples the keyboard navigation module 14 of the present disclosure may run as an embedded application in a virtual runtime environment. Further, the present embodiments are not limited to a browser-based environment, but may be utilized with any type of application built on markup languages such as HTML and including Javascript elements, etc.

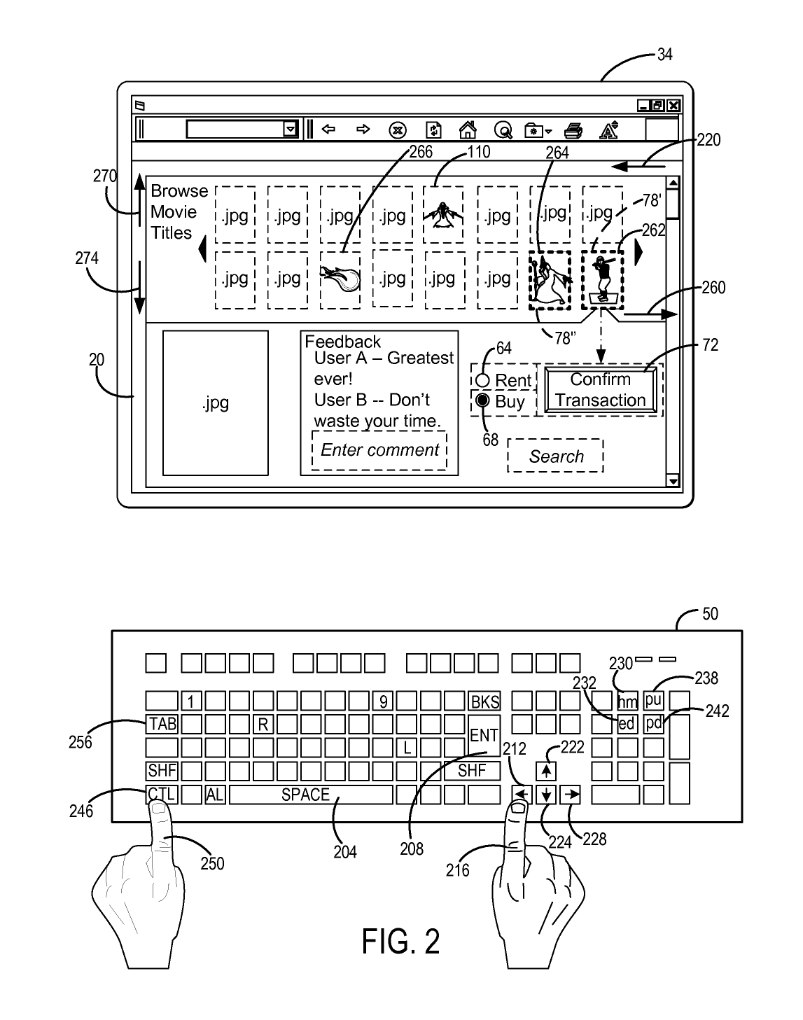

With reference also to FIG. 2, in one example the movie application 46 may be configured to access web resource 18 and display multiple movie listings that are available for rent or purchase. Each movie listing may comprise one or more HTML elements. FIG. 1 illustrates four of the movie listings in web resource 18 in the form of Movie1 link HTML element 110, Movie2 link HTML element 114, Movie3 link HTML element 118, and Movie4 link HTML element 122. It will be appreciated that additional movie listing HTML elements may also be included in web resource 18. In this example, web resource 18 also includes a search box HTML element 86, a feedback HTML element 90, and a container HTML element 60 including a rent radio button 64, a buy radio button 68, and a confirm button 72.

As shown in FIG. 2, these and other HTML elements may be rendered and displayed on display 34 within a graphical user interface (GUI) 20. In some examples, one or more of these HTML elements may include multiple items, such as text, images, selectable input mechanisms such as buttons, etc.

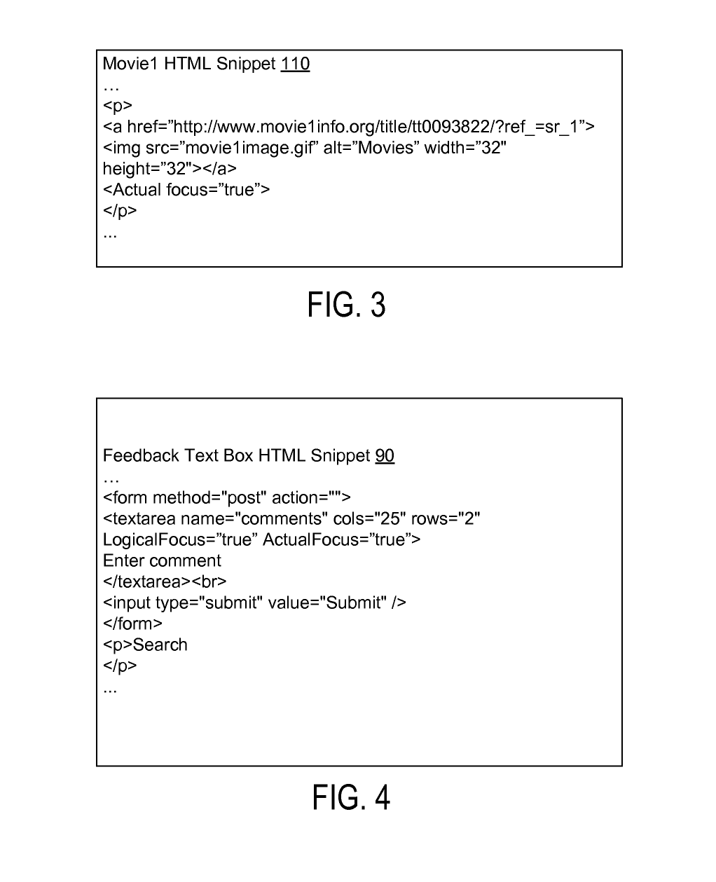

A developer of web resource 18 may mark each of the Movie1 link HTML element 110, Movie2 link HTML element 114, Movie3 link HTML element 118, and Movie4 link HTML element 122 as capable of receiving input from the keyboard navigation module 14. In one example, and as explained in more detail below, each of these elements may include a logical focus attribute 66 and/or an actual focus attribute 70 that identifies the element as capable of receiving input from the keyboard navigation module 14. FIG. 3 shows one example of a portion of pseudocode of the Movie1 link HTML element 110 that includes an actual focus attribute 70.

An actual focus attribute 70 may be included with an HTML element that is intended to be displayed. A logical focus attribute 66 may be included with an HTML element that may receive keyboard focus, as described in more detail below, but is not intended to be displayed to the user 62. In one example the actual focus attribute 70 may be denoted data-ent-actualfocustarget and the logical focus attribute 66 may be denoted data-ent-logicalfocustarget. A logical focus attribute 66 may attach to the root of the HTML element being managed. An actual focus attribute 70 may attach to a sub-element of the HTML element being managed, such as a sub-element configured to receive and process a selection by the user 62.

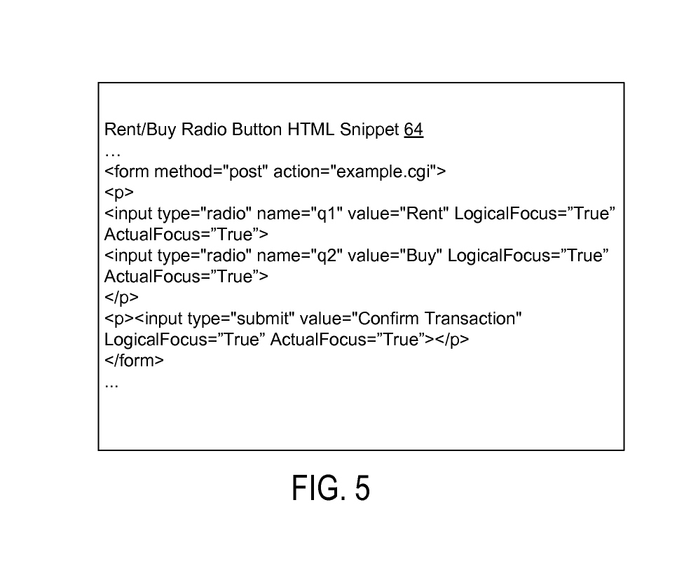

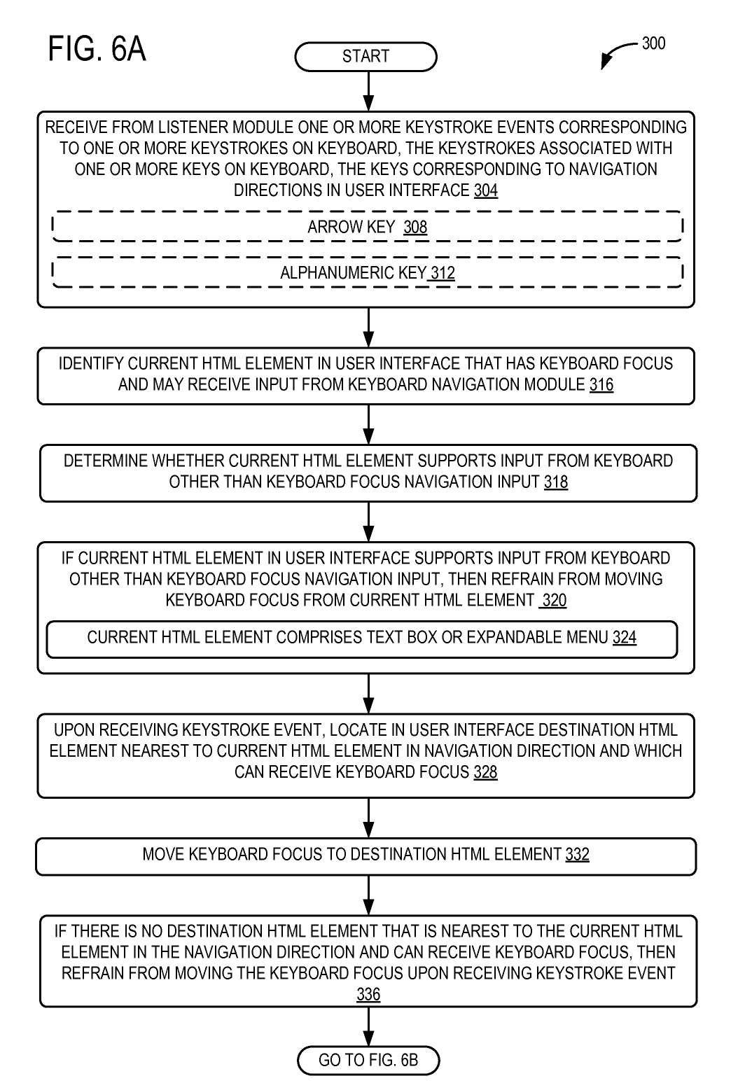

In one example, an HTML element may have both a logical focus attribute 66 and an actual focus attribute 70. For example, FIG. 4 shows one example of a portion of pseudocode of the Feedback Text Box HTML element 90 that includes an actual focus attribute and a logical focus attribute. FIG. 5. shows one example of a portion of pseudocode of the Rent/Buy Radio Button HTML element 64 that includes an actual focus attribute and a logical focus attribute.

In another example, an HTML element may have a logical focus attribute 66 and an actual focus attribute 70 as a descendant in the DOM tree. For example and with reference to FIG. 1, the container HTML element 60 may have a parent-child relationship with the Rent radio button 64, Buy radio button 68, and confirm button 72. In another example, a container HTML element having a logical focus attribute denoted data-ent-logicalfocustarget and an actual focus attribute denoted data-ent-actualfocustarget may be expressed as follows:

```
            <div style=“-ms-grid-column: 1; -ms-grid-row: 1;”
            data-ent-logicalfocustarget=“true”
            class=“dashboardGridItemContent”
            data-win-bind=“clickDataContext: bindableItems.item0”>
            <div class=“thumbnailButton”
              role=“button”
              aria-atomic=“true”
              data-ent-actualfocustarget=“true”>
              <div class=“imageContainer”
              aria-hidden=“true”>
              <!-- Thumbnail Image -->
              <img class=“imageHolder”
                data-win-
control=“MS.Entertainment.UI.Shell.ImageControl”
                data-win-bind=“winControl.target:
bindableItems.item0.imagePrimaryUrl”
                data-win-options=“{defaultImagePath: “}”
                width=“220”
                height=“165”/>
            </div>
            <!-- Text Labels -->
            <div class=“content”>
              <div class=“textContainer”>
                <div class=“primaryTextBg”></div>
                <div class=“primaryText label”
                  data-win-bind=“textContent:
bindableItems.item0.primaryText;
                          removeFromDisplay:
bindableItems.item0.primaryText
MS.Entertainment.Utilities.toggleClassNameOnEmptyString;”></div>
                <div class=“secondaryText label”
                  data-win-bind=“textContent:
bindableItems.item0.secondaryText;
                          removeFromDisplay:
bindableItems.item0.secondaryText
MS.Entertainment.Utilities.toggleClassNameOnEmptyString;”></div>
                <div class=“icon dashboardTileIcon”
                  data-win-bind=“textContent:
MS.Entertainment.UI.Icon.dpadRight
MS.Entertainment.Formatters.formatIcon;
                          removeFromDisplay;
bindableItems.item0.isFlexHub
MS.Entertainment.Utilities.toggleClassNameNegate;”></div>
              </div>
            </div>
          </div>
        </div>
```

In one example, the keyboard navigation module 14 attaches to a root HTML DOM element from which the module may perform one or more actions. As explained in more detail below, a keystroke event 58 associated with one or more keys on the keyboard 50 may occur, and such key or keys may correspond to a navigation direction in the user interface. As discussed below, arrow keys may be used to navigate in up, down, right and left directions in the user interface. In this example, the keyboard navigation module 14 may locate in the user interface a destination HTML element that is nearest to the current HTML element in the navigation direction and can receive keyboard focus. The keyboard navigation module 14 may then move the keyboard focus to the destination HTML element in the navigation direction that corresponds to the depressed arrow key, for example.

In one example and with reference to FIGS. 1 and 3, the Movie1 link HTML element 110 may include an actual focus attribute 70 and a selectable input mechanism in the form of an anchor element including the target URL “http://www.movie1.org/title/tt0093822/?ref_=sr_{—}1”. A focus indicator 78 may indicate to the user 62 that Movie1 link HTML element 110 currently has keyboard focus. For purposes of this disclosure, an HTML element has keyboard focus when that element is currently selected to receive keyboard input. In one example as shown in FIG. 1, the focus indicator 78 may comprise a dashed ring encircling the HTML element that has keyboard focus. It will be appreciated that the focus indicator 78 may take any one of many other suitable forms such as, for example, highlighting the element in black, white or other color, displaying a transparent box over the element, changing color of the element, giving motion to the element, drawing a boundary box around the element, etc.

In one example, an instance of the keyboard navigation module 14 may be instantiated and attached to the root DOM element of the GUI 20 that manages navigation of the movie application 46. In this manner the keyboard navigation module 14 may identify the HTML elements that include a logical focus attribute 66 and/or actual focus attribute 70. Upon instantiation of an instance of the keyboard navigation module 14, the listener module 42 may be attached to detect keystroke events 58 from the keyboard 50. In some examples, the listener module 42 may be native to the keyboard navigation module 14. In other examples, the listener module 42 may take the form of an existing key listener from, for example, a web browser.

With continued reference to FIG. 2, in one use case example each movie HTML element may include an in-line image representing the movie that is rendered and displayed in a tile. The keyboard navigation module 14 may identify a Baseball Movie HTML element 262 as the current HTML element in the GUI 20 that has keyboard focus, as indicated by indicator 78′. The user 62 may perform a keystroke by pressing a left arrow key 212 with the user's right index finger 216. The left arrow key 212 may correspond to a left navigation direction 220 in the movie application GUI 20. A keystroke event 58 corresponding to the user's keystroke may be received by the keyboard navigation module 14 via the listener module 42.

The keyboard navigation module 14 may identify the Baseball Movie HTML element 262 as the current element that has keyboard focus and as an element that may receive input from the keyboard navigation module. Upon receiving the keystroke event corresponding to the left arrow key 212, the keyboard navigation module 14 may locate in the GUI 20 a destination HTML element that is nearest to the Baseball Movie HTML element 262 in the navigation direction 220 and that can receive the keyboard focus. In this example, moving in the navigation direction 220 from the Baseball Movie HTML element 262, a Wizard Movie HTML element 264 is the nearest element to the Baseball Movie HTML element 262 and may receive keyboard focus. Accordingly, the keyboard navigation module 14 moves the keyboard focus from the Baseball Movie HTML element 262 to the Wizard Movie HTML element 264, such that the Wizard Movie HTML element now has keyboard focus, as indicated by indicator 78″.

In one example, to locate the destination HTML element the keyboard navigation module 14 may perform an HTML querySelector function from the root element given to the keyboard navigation module 14 to find those elements marked with a logical focus attribute 66, while filtering out those elements that are not currently visible. In this manner, the navigation module 14 may create a filtered list of HTML elements marked with a logical focus attribute 66 that are currently visible.

In another use case example involving the same user keystroke corresponding to the left arrow key 212, the Wizard Movie HTML element 264 may not be configured to receive keyboard focus. The next HTML element in the navigation direction 220 that can receive keyboard focus may be a Fire Movie HTML element 266. In this example, upon receiving the keystroke the keyboard navigation module 14 may locate the Fire Movie HTML element 266 as the destination HTML element that is nearest to the Baseball Movie HTML element 262 in the navigation direction 220 and that can receive keyboard focus. Accordingly, the keyboard navigation module 14 may move the keyboard focus from the Baseball Movie HTML element 262 to the Fire Movie HTML element 266.

It will be appreciated that any suitable keys on the keyboard 50 may be configured to correspond to a navigation direction or instruction. For example, the other 3 direction keys 222, 224 and 228 that each indicates a different navigation direction in the GUI 20 may be utilized by the keyboard navigation module 14. In another example, one or more alphanumeric keys may be utilized to indicate one or more navigation directions instructions.

In another example, upon receiving a keystroke event corresponding to a HOME key 230, the keyboard navigation module 14 may locate the first HTML item in the filtered list described above. Similarly, upon receiving a keystroke event corresponding to an END key 232, the keyboard navigation module 14 may locate the last HTML item in the filtered list described above.

In another example, upon receiving a keystroke event corresponding to a PAGE UP key 238, the keyboard navigation module 14 may locate the nearest HTML element that is off-screen in the navigation direction 270. Similarly, upon receiving a keystroke event corresponding to a PAGE DOWN key 242, the keyboard navigation module 14 may locate the nearest HTML item that is off-screen in navigation direction 274.

In other examples, combinations of keys may be utilized to indicate different navigation directions. For example and with reference to FIG. 2, the user 62 may simultaneously press the CONTROL button 246 with the user's left index finger 250 and left arrow key 212 with the right index finger 216 to modify the navigation of the keyboard focus. Such modified navigation may comprise, for example, skipping over the next HTML element that otherwise would be selected to a following HTML element. It will be appreciated that any other suitable combinations of keys on the keyboard 50 may be similarly configured and utilized, and any suitable corresponding navigation modification may be provided.

In another use case example in which the Baseball Movie HTML element 262 is identified as the current HTML element in the GUI 20 that has keyboard focus, the user 62 may perform a keystroke by pressing the right arrow key 228. The right arrow key 228 may correspond to a right navigation direction 260 in the movie application GUI 20. A keystroke event 58 corresponding to the user's keystroke may be received by the keyboard navigation module 14 via the listener module 42.

Upon receiving the keystroke event corresponding to the right arrow key 228, and where the Baseball Movie HTML element 262 is the right-most HTML element on the display 34 that can receive keyboard focus, the keyboard navigation module 14 may determine that there is no destination HTML element that is nearest to the Baseball Movie HTML element 262 in the navigation direction 260 and that can receive the keyboard focus. Accordingly, in this example the keyboard navigation module 14 may refrain from moving the keyboard focus 78′ upon receiving the keystroke event 58.

In another example, a tab index attribute may be associated with a current HTML element to enable tab stop navigation to the current HTML element. In one example and with reference to FIG. 1, the Movie2 link HTML element 114 may include the current HTML element and a tab index attribute 82 corresponding to a tab stop navigation process. In one example of such a process, each press of the TAB key 256 on keyboard 50 may advance the focus indicator 78 sequentially to the next HTML element that includes a tab index attribute 82. Advantageously, in this example keyboard focus may be moved via a tab stop navigation process in addition to via one or more keys corresponding to a navigation direction in the user interface as described above.

In another example, the keyboard navigation module 14 may determine whether the current HTML element in the user interface also supports input from the keyboard other than keyboard focus navigation input. For example, the GUI 20 may include a search box input tool HTML element 86 that is associated with an actual focus attribute 70. The search box input tool HTML element 86 may comprise a text field in which the user 62 may type a movie title, actor's name, or other information to search. In other examples, the search box HTML element 86 may comprise an expandable menu such as a drop-down menu.

In one example where the search box HTML element 86 is a text edit box and is the current HTML element, the keyboard navigation module 14 may determines that the current HTML element supports input from the keyboard other than keyboard focus navigation input. Accordingly, the keyboard navigation module 14 may refrain from moving the keyboard focus to the destination HTML element upon receiving one or more keystroke events that otherwise would move the keyboard focus. In this manner, the user 62 may use any keys to input text into the search box 86 without those keystroke events 58 moving the keyboard focus away from the search box 86.

In another example and with reference to FIG. 2, the current HTML element may comprise a selectable input mechanism, such as the selectable “Confirm Transaction” button 72 associated with the Rent radio button 64 and Buy radio button 68. The keys on the keyboard 50 may include an ENTER key 208 and a SPACE key 204. When keyboard focus is on the Confirm Transaction button 72, the keyboard navigation module 14 may be configured to select the “Confirm Transaction” button 72 upon receiving a keystroke event 58 that is associated with the enter key 208 or the space key 204. It will be appreciated that in other examples keystroke events 58 associated with any other key may also be configured to trigger selection of the “Confirm Transaction” button 72.

When the “Confirm Transaction” button 72 is selected by the user 62, listener module 42 may detect the selection, and the movie application 46 may process the input according to program logic to perform one or more actions. For example, where the user 62 has selected the Buy radio button 68, such action may include displaying a dialogue box that provides a purchase confirmation for the selected movie. It will be appreciated that many other actions may also be performed upon selection of the “Confirm Transaction” button 72, such as for example navigating to a destination URL. It will also be appreciated that the user 62 may select the button 72 in any suitable manner and with any suitable one or more keys.

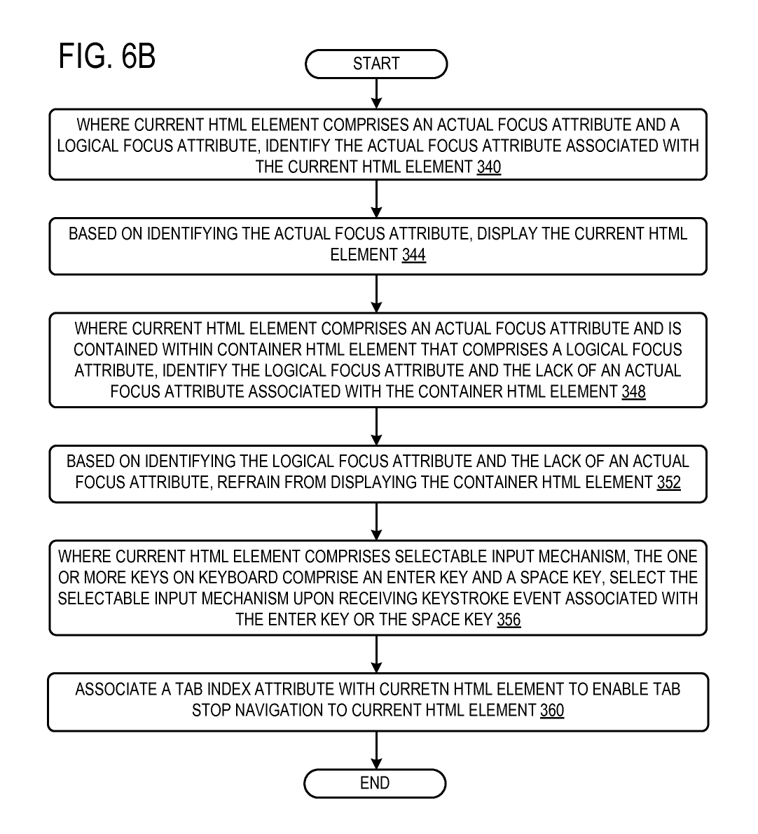

FIGS. 6A and 6B illustrate a flow chart of a method 300 of navigating a user interface via a keyboard according to an embodiment of the present disclosure. The following description of method 300 is provided with reference to the software and hardware components of the keyboard navigation system 10 described above and shown in FIGS. 1-5. It will be appreciated that method 300 may also be performed in other contexts using other suitable hardware and software components.

With reference to FIG. 6A, at 304 the method 300 includes receiving from a listener module one or more keystroke events corresponding to one or more keystrokes on the keyboard, with the one or more keystrokes associated with one or more keys on the keyboard. The one or more keys also correspond to a navigation direction in the user interface. At 308 one or more of the keys may comprise an arrow key, while at 312 one or more of the keys may comprise an alphanumeric key.

At 316 the method 300 includes identifying a current HTML element in the user interface that has a keyboard focus and may receive input from the keyboard navigation module. At 318 the method 300 includes determining whether the current HTML element also supports input from the keyboard other than keyboard focus navigation input. At 320, and if the current HTML element supports input from the keyboard other than keyboard focus navigation input, then the method 300 includes refraining from moving the keyboard focus to the destination HTML element upon receiving the one or more keystroke events. At 324 the current HMTL comprises a text edit box or an expandable menu, where the text edit box or the expandable menu supports input from the keyboard other than keyboard focus navigation input.

At 328 and upon receiving the one or more keystroke events, the method 300 includes locating in the user interface a destination HTML element that is nearest to the current HTML element in the navigation direction and is capable of receiving the keyboard focus. At 332 the method 300 then includes moving the keyboard focus to the destination HTML element.

At 336, if there is no destination HTML element that is nearest to the current HTML element in the navigation direction and can receive the keyboard focus, then the method 300 includes refraining from moving the keyboard focus upon receiving the one or more keystroke events. With reference now to FIG. 6B and at 340, where the current HTML element comprises an actual focus attribute and a logical focus attribute, the method 300 includes identifying the actual focus attribute associated with the current HTML element. At 344, and based on identifying the actual focus attribute, the method 300 includes displaying the current HTML element.

At 348, where the current HTML element comprises an actual focus attribute and is contained within a container HTML element that includes a logical focus attribute, the method 300 includes identifying the logical focus attribute associated with the container HTML element and identifying the absence of an actual focus attribute associated with the container HTML element. At 352 and based on identifying the logical focus attribute and the absence of an actual focus attribute in the container HTML element, the method 300 includes refraining from displaying the container HTML element.

At 356, where the current HTML element comprises a selectable input mechanism, and one or more keys on the keyboard comprise an enter key and a space key, the method 300 includes selecting the selectable input mechanism upon receiving a keystroke event that is associated with the enter key or the space key. At 360 the method 300 includes associating a tab index attribute with the current HTML element to enable tab stop navigation to the current HTML element.

It will be appreciated that method 300 is provided by way of example and is not meant to be limiting. Therefore, it is to be understood that method 300 may include additional and/or alternative steps than those illustrated in FIGS. 6A and 6B. Further, it is to be understood that method 300 may be performed in any suitable order. Further still, it is to be understood that one or more steps may be omitted from method 300 without departing from the scope of this disclosure.

FIG. 7 schematically shows a nonlimiting embodiment of a computing system 400 that may perform one or more of the above described methods and processes. Computing device 12 may take the form of computing system 400. Computing system 400 is shown in simplified form. It is to be understood that virtually any computer architecture may be used without departing from the scope of this disclosure. In different embodiments, computing system 400 may take the form of a mainframe computer, server computer, desktop computer, laptop computer, tablet computer, home entertainment computer, network computing device, mobile computing device, mobile communication device, gaming device, etc.

As shown in FIG. 7, computing system 400 includes a logic subsystem 404 and a storage subsystem 408. Computing system 400 may optionally include a display subsystem 412, a communication subsystem 416, an input subsystem 420 and/or other subsystems and components not shown in FIG. 7. Computing system 400 may also include computer readable media, with the computer readable media including computer readable storage media and computer readable communication media. Computing system 400 may also optionally include other user input devices such as keyboards, mice, game controllers, and/or touch screens, for example. Further, in some embodiments the methods and processes described herein may be implemented as a computer application, computer service, computer API, computer library, and/or other computer program product in a computing system that includes one or more computers.

Logic subsystem 404 may include one or more physical devices configured to execute one or more instructions. For example, the logic subsystem 404 may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem 404 may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Storage subsystem 408 may include one or more physical, persistent devices configured to hold data and/or instructions executable by the logic subsystem 404 to implement the herein described methods and processes. When such methods and processes are implemented, the state of storage subsystem 408 may be transformed (e.g., to hold different data).

Storage subsystem 408 may include removable media and/or built-in devices. Storage subsystem 408 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Storage subsystem 408 may include devices with one or more of the following characteristics: volatile, nonvolatile, dynamic, static, read/write, read-only, random access, sequential access, location addressable, file addressable, and content addressable.

In some embodiments, aspects of logic subsystem 404 and storage subsystem 408 may be integrated into one or more common devices through which the functionally described herein may be enacted, at least in part. Such hardware-logic components may include field-programmable gate arrays (FPGAs), program- and application-specific integrated circuits (PASIC/ASICs), program- and application-specific standard products (PSSP/ASSPs), system-on-a-chip (SOC) systems, and complex programmable logic devices (CPLDs), for example.

FIG. 7 also shows an aspect of the storage subsystem 408 in the form of removable computer readable storage media 424, which may be used to store data and/or instructions executable to implement the methods and processes described herein. Removable computer-readable storage media 424 may take the form of CDs, DVDs, HD-DVDs, Blu-Ray Discs, EEPROMs, and/or floppy disks, among others.

It is to be appreciated that storage subsystem 408 includes one or more physical, persistent devices. In contrast, in some embodiments aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal via computer-readable communication media.

When included, display subsystem 412 may be used to present a visual representation of data held by storage subsystem 408. As the above described methods and processes change the data held by the storage subsystem 408, and thus transform the state of the storage subsystem, the state of the display subsystem 412 may likewise be transformed to visually represent changes in the underlying data. The display subsystem 412 may include one or more display devices utilizing virtually any type of technology. Such display devices may be combined with logic subsystem 404 and/or storage subsystem 408 in a shared enclosure, or such display devices may be peripheral display devices.

When included, communication subsystem 416 may be configured to communicatively couple computing system 400 with one or more networks and/or one or more other computing devices. Communication subsystem 416 may include wired and/or wireless communication devices compatible with one or more different communication protocols. As nonlimiting examples, the communication subsystem 416 may be configured for communication via a wireless telephone network, a wireless local area network, a wired local area network, a wireless wide area network, a wired wide area network, etc. In some embodiments, the communication subsystem may allow computing system 400 to send and/or receive messages to and/or from other devices via a network such as the Internet.

When included, input subsystem 420 may comprise or interface with one or more sensors or user-input devices such as a game controller, gesture input detection device, voice recognizer, inertial measurement unit, keyboard, mouse, or touch screen. In some embodiments, the input subsystem 420 may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

The terms “module” and “program” may be used to describe an aspect of the keyboard navigation system 10 that is implemented to perform one or more particular functions. In some cases, such a module or program may be instantiated via logic subsystem 404 executing instructions held by storage subsystem 408. It is to be understood that different modules and programs may be instantiated from the same application, service, code block, object, library, routine, API, function, etc. Likewise, the same module or program may be instantiated by different applications, services, code blocks, objects, routines, APIs, functions, etc. The terms “module” and “program” are meant to encompass individual or groups of executable files, data files, libraries, drivers, scripts, database records, etc.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A keyboard navigation system for navigating a user interface via a keyboard, the keyboard navigation system comprising:
a keyboard navigation module executed by a processor of a computing device, the keyboard navigation module configured to:
receive from a listener module one or more keystroke events corresponding to one or more keystrokes on the keyboard, the one or more keystrokes associated with one or more keys on the keyboard, wherein the one or more keys correspond to a navigation direction in the user interface;
identify a current HTML element in the user interface that has a keyboard focus and may receive input from the keyboard navigation module;
upon receiving the one or more keystroke events, locate in the user interface a destination HTML element that is nearest to the current HTML element in the navigation direction and can receive the keyboard focus; and
move the keyboard focus to the destination HTML element.

2. The keyboard navigation system of claim 1, wherein the one or more keys comprise an arrow key.

3. The keyboard navigation system of claim 1, wherein the one or more keys are selected from the group consisting of four arrow keys that each indicate a different navigation direction in the user interface.

4. The keyboard navigation system of claim 1, wherein the one or more keys comprise an alphanumeric key.

5. The keyboard navigation system of claim 1, wherein the keyboard navigation module is further configured to:
determine whether the current HTML element in the user interface also supports input from the keyboard other than keyboard focus navigation input; and
if the current HTML element in the user interface supports input from the keyboard other than keyboard focus navigation input, then refrain from moving the keyboard focus to the destination HTML element upon receiving the one or more keystroke events.

6. The keyboard navigation system of claim 1, wherein the keyboard navigation module is further configured to, if there is no destination HTML element that is nearest to the current HTML element in the navigation direction and can receive the keyboard focus, then refrain from moving the keyboard focus upon receiving the one or more keystroke events.

7. The keyboard navigation system of claim 1, wherein the current HTML element comprises an actual focus attribute and a logical focus attribute, and the keyboard navigation module is further configured to:
identify the actual focus attribute associated with the current HTML element; and
based on identifying the actual focus attribute, display the current HTML element.

8. The keyboard navigation system of claim 1, wherein the current HTML element comprises an actual focus attribute and is contained within a container HTML element that comprises a logical focus attribute, and the keyboard navigation module is further configured to:
identify the logical focus attribute associated with the container HTML element;
identify an absence of an actual focus attribute associated with the container HTML element; and
based on identifying the logical focus attribute and the absence of an actual focus attribute, refrain from displaying the container HTML element.

9. The keyboard navigation system of claim 1, wherein the current HTML element comprises a selectable input mechanism, the one or more keys on the keyboard comprise an enter key and a space key, and the keyboard navigation module is further configured to select the selectable input mechanism upon receiving a keystroke event that is associated with the enter key or the space key.

10. A method of navigating a user interface via a keyboard, the method comprising:
receiving from a listener module one or more keystroke events corresponding to one or more keystrokes on the keyboard, the one or more keystrokes associated with one or more keys on the keyboard, wherein the one or more keys correspond to a navigation direction in the user interface;
identifying a current HTML element in the user interface that has a keyboard focus and may receive input from a keyboard navigation module;
upon receiving the one or more keystroke events, locating in the user interface a destination HTML element that is nearest to the current HTML element in the navigation direction and can receive the keyboard focus; and
moving the keyboard focus to the destination HTML element.

11. The method of claim 10, wherein the one or more keys comprise an arrow key.

12. The method of claim 10, wherein the one or more keys comprise an alphanumeric key.

13. The method of claim 10, further comprising:
determining whether the current HTML element in the user interface also supports input from the keyboard other than keyboard focus navigation input; and
if the current HTML element in the user interface supports input from the keyboard other than keyboard focus navigation input, then refraining from moving the keyboard focus to the destination HTML element upon receiving the one or more keystroke events.

14. The method of claim 13, wherein the current HTML element comprises a text edit box or an expandable menu, where the text edit box or the expandable menu supports input from the keyboard other than keyboard focus navigation input.

15. The method of claim 10, further comprising, if there is no destination HTML element that is nearest to the current HTML element in the navigation direction and can receive the keyboard focus, then refraining from moving the keyboard focus upon receiving the one or more keystroke events.

16. The method of claim 10, wherein the current HTML element comprises an actual focus attribute and a logical focus attribute, the method further comprising:
identifying the actual focus attribute associated with the current HTML element; and
based on identifying the actual focus attribute, displaying the current HTML element.

17. The method of claim 10, wherein the current HTML element comprises an actual focus attribute and is contained within a container HTML element that comprises a logical focus attribute, the method further comprising:
identifying the logical focus attribute associated with the container HTML element;
identifying an absence of an actual focus attribute associated with the container HTML element; and
based on identifying the logical focus attribute and the absence of an actual focus attribute, refraining from displaying the container HTML element.

18. The method of claim 10, wherein the current HTML element comprises a selectable input mechanism, the one or more keys on the keyboard comprise an enter key and a space key, the method further comprising selecting the selectable input mechanism upon receiving a keystroke event that is associated with the enter key or the space key.

19. The method of claim 10, the method further comprising associating a tab index attribute with the current HTML element to enable tab stop navigation to the current HTML element.

20. A method of navigating a user interface via a keyboard, the method comprising:
receiving from a listener module a keystroke event corresponding to a keystroke on the keyboard, the keystroke associated with one of four arrow keys that each indicate a different navigation direction in the user interface;
identifying a current HTML element in the user interface that has a keyboard focus and may receive input from a keyboard navigation module;
upon receiving the keystroke event, locating in the user interface a destination HTML element that is nearest to the current HTML element in the navigation direction indicated by the one of the four arrow keys associated with the keystroke, the destination HTML element capable of receiving the keyboard focus; and
moving the keyboard focus to the destination HTML element.
